(19) United States
(12) Patent Application Publication
(10) Pub. No.: US 2006/0227122 A1
(43) Pub. Date: Oct. 12, 2006

(54) Implementing multiple display modes on one display panel

(75) Inventor: David W. Proctor, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/102,460

(22) Filed: Apr. 7, 2005

(51) Int. Cl. G09G 5/00

(52) U.S. Cl. 345/204

(57) ABSTRACT

An electronic device has a single display panel that operates in multiple modes to support different display capabilities. In one implementation, the device operates the display panel in a first mode to support a rich user experience, such as watching video, playing games, reading and writing email, and so forth. In the first mode, the entire display panel is operational, where substantially all of the pixels are active and available to depict image data. The device alternatively operates the display panel in a second mode that provides limited display capabilities, while conserving power. In the second mode, a portion of the display panel is operational while the rest of the display panel is powered off. This partial display mode may be implemented by activating a subset of the pixels, certain backlights, and/or a part of the circuitry that supports the display (e.g., frame buffer, display controller).

### TECHNICAL FIELD

This disclosure relates to displays and techniques for presenting information on displays.

### BACKGROUND

Portable electronics devices are commonplace and widespread. Traditionally, these devices were designed to perform a single function. Cellular phones enabled wireless communication, PDAs (portable digital assistants) maintained calendars and email, MP3 players provided music storage and playback, digital cameras captured digital images, and personal video players played movies or other video content. Today, portable devices are designed to support multiple functions. Cellular phones not only facilitate wireless communication, but also allow users to take digital pictures, receive and send email, play games, and store and playback music.

These various functions have different display requirements. Certain functions can be supported with small, low power displays. MP3 players and cell phones, for example, can use limited displays to show alphanumeric characters for song title and track information, phone numbers, or time-of-day. Other functions, however, require more sophisticated displays. Higher resolution color displays are preferable for depicting digital images, reading and writing emails, or watching video.

Power consumption is another important consideration for designers of portable devices. Designers continually look for ways to conserver power. Displays are one primary consumer of power, often accounting for anywhere from 20% to 60% of the power consumption of the entire electronic device. In display panels, such as those used in portable electronic devices, power consumption is proportion to the number of pixels being driven. Today, displays are either on or off. When on, all pixels are active and consuming power, even if the display does not depict images on the entire screen. After a time-out period or in response to a user command, the display is turned off where all pixels are inactive and not consuming power.

Because of power consumption issues and different display requirements for supporting multiple functions, designers have turned to using two different displays—a small, limited feature display for simple or rudimentary functions and a large, high feature display for more enhanced functions. As one example, many of the “clamshell” or “flip-phone” models of cellular phones use two displays. A small, low power display is visible on the outside of the phone when its lid is flipped shut. This external display can show limited information (e.g., time-of-day, power reserves, cell signal strength, etc.) and requires very little power while waiting for a phone call. A larger color display is exposed on the inside when the lid is flipped open. This larger display can be used to read and write email, display pictures captured by a built-in camera, play games, or watch video clips.

Unfortunately, adding a second display increases the cost and complexity of the device.

Accordingly, there is a need to improve the way information is displayed on such multi-function devices, allowing better power conservation, while decreasing their cost and complexity.

### SUMMARY

An electronic device has a single display panel that operates in multiple modes to support different display capabilities. In one implementation, the device operates the display panel in a first mode to support a rich user experience, such as watching video, playing games, reading and writing email, and so forth. In the first mode, the entire display panel is operational, where substantially all pixels are active and available to depict image data. While this mode offers the highest quality user experience, it is also consumes the most power. The device alternatively operates the display panel in a second mode that supports limited display capabilities, such as depicting alphanumeric characters and small graphics. In the second mode, a portion of the display panel is operational while the rest of the display panel is powered off. This partial display mode may be implemented by controlling on/off select rows and columns of pixels, where a subset of the pixels is active and available to depict data and the rest of the pixels are powered off. Additionally, or alternatively, the partial display mode might involve turning on or off portions of backlighting, or circuitry that supports the display panel. As a result, power is conserved as only a portion of the display is operational in the second display mode.

### BRIEF DESCRIPTION OF THE CONTENTS

The detailed description is described with reference to the accompanying figures. In the figures, the left-most digit(s) of a reference number identifies the figure in which the reference number first appears. The use of the same reference numbers in different figures indicates similar or identical items.

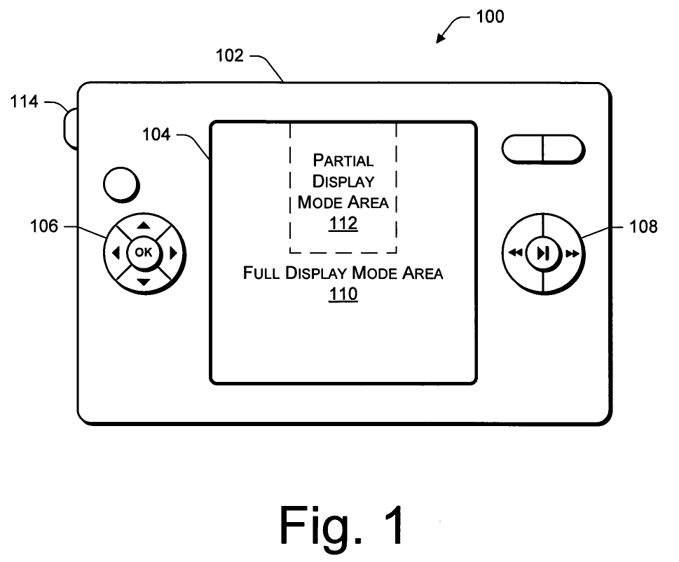

FIG. 1 illustrates a portable entertainment device that implements multiple display modes for a single display panel.

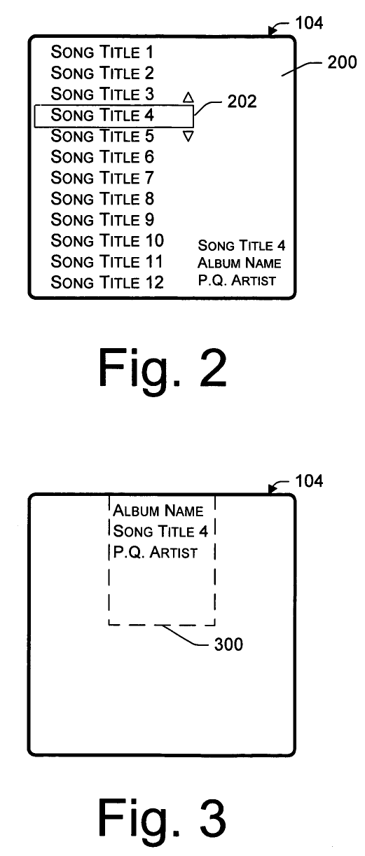

FIG. 2 illustrates an exemplary full display mode where all pixels are active.

FIG. 3 illustrates an exemplary partial display mode where less than all pixels are active.

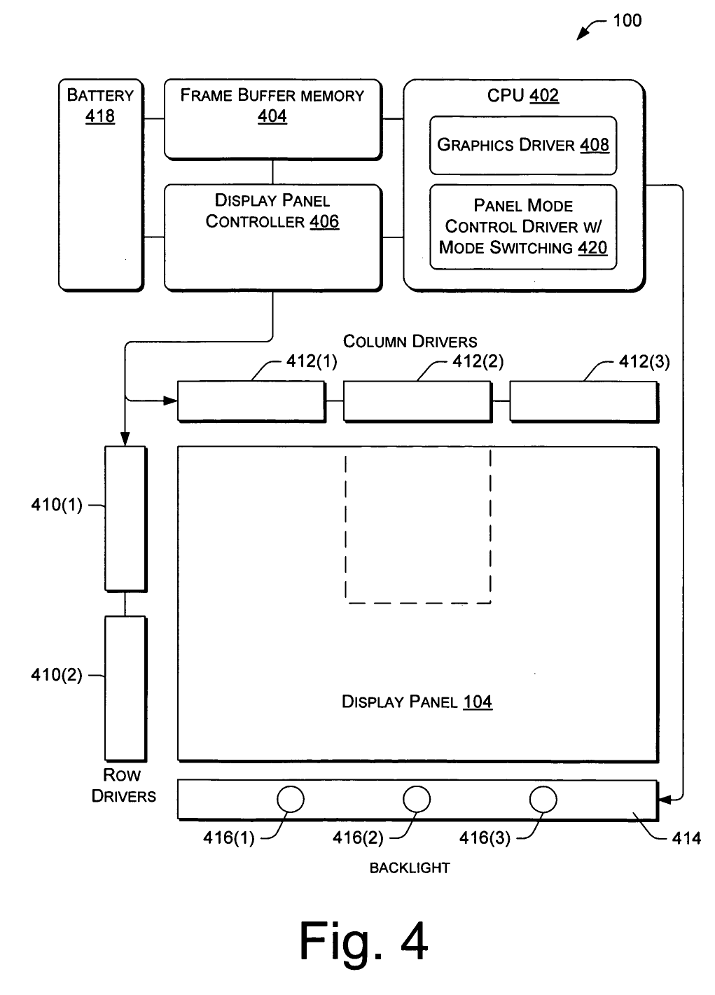

FIG. 4 is a block diagram of a device that implements the two display modes for a single display panel according to a first implementation.

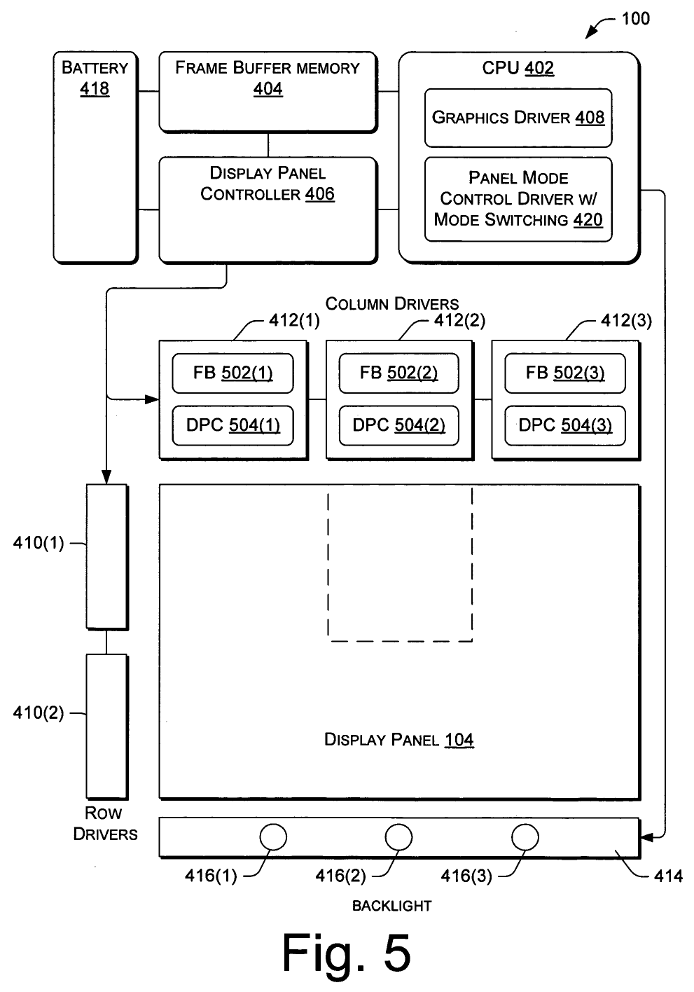

FIG. 5 is a block diagram of a device that implements the two display modes for a single display panel according to a second implementation.

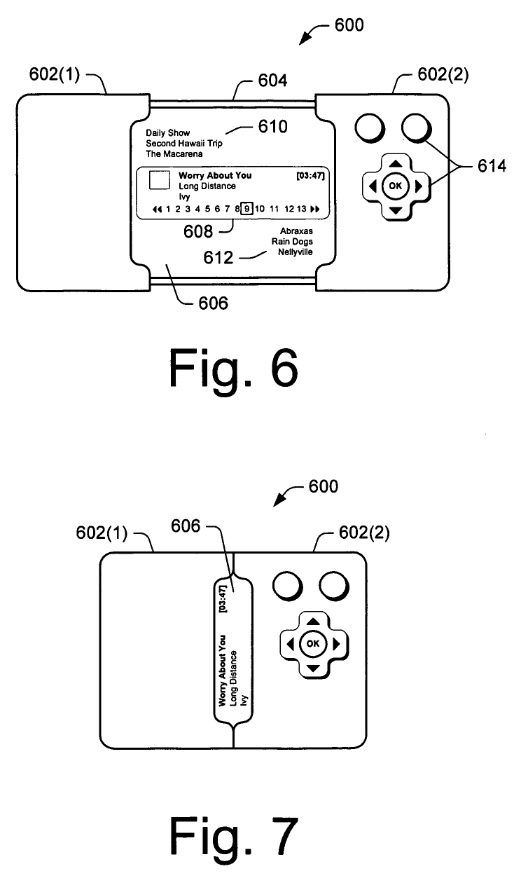

FIGS. 6 and 7 illustrate an audio player that implements two display modes for a single display panel.

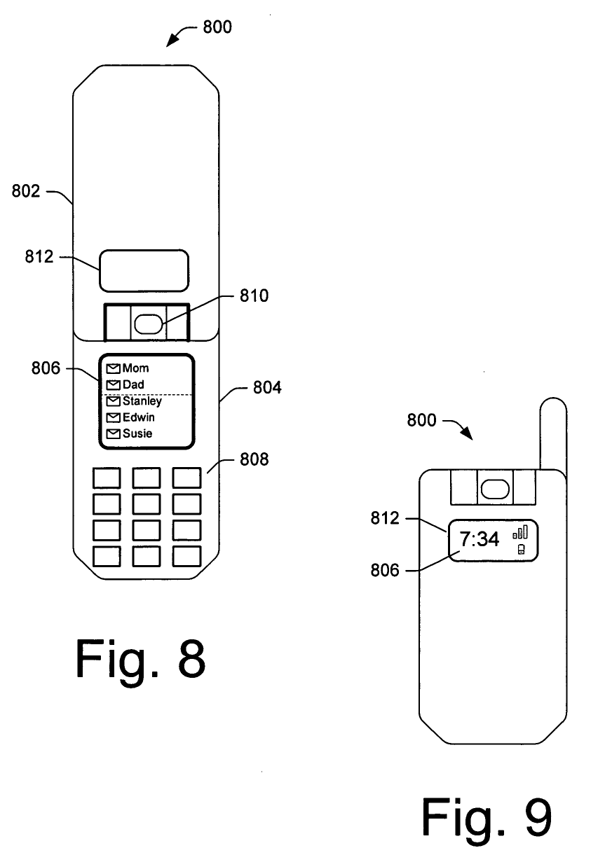

FIGS. 8 and 9 illustrate a cellular phone that implements two display modes for a single display panel.

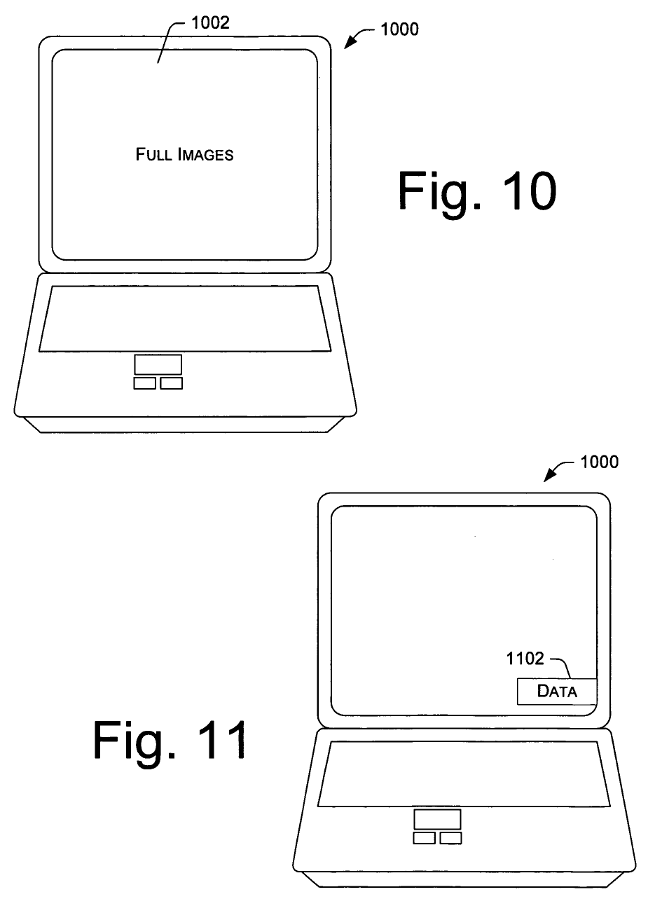

FIGS. 10 and 11 illustrate a flat screen display that implements two display modes for a single display panel.

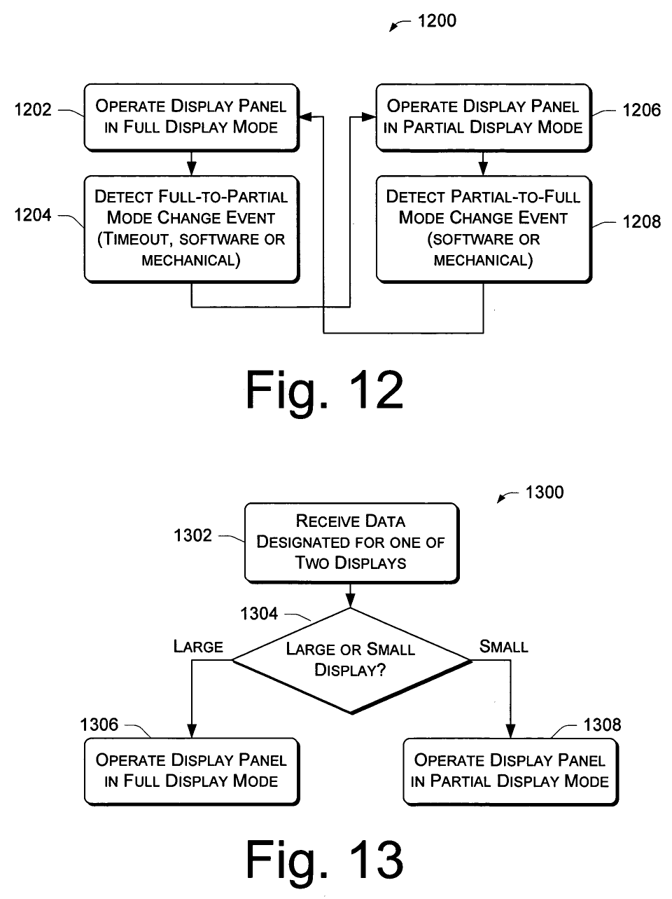

FIG. 12 is a flow diagram of a process for operating a device with a single display panel in multiple display modes.

FIG. 13 is a flow diagram of a process for using dual display modes with existing hardware and software designed to support two separate display panels.

### DETAILED DESCRIPTION

This disclosure is directed to implementing two or more display modes on a single display. In the described implementation, the display is a relatively large, color, high-feature display panel that is capable of depicting text, graphics, digital images, motion video, and the like. In a first or full display mode, the entire display, including all pixels and any backlighting, is on and available for depicting image data. The display panel thus functions as a full-feature “first display” that can be used to show videos, play games, render graphics, read and write email, browse the Internet, and so forth. In a second or partial display mode, only a portion of the display is used while the rest of the display is turned off and not drawing power. The smaller portion of the display is defined by activating a subset of the pixels, certain backlights (if any), and/or a part of the circuitry for the display (e.g., frame buffer, display controller). The smaller display portion thus functions as a “second display” that offers limited functionality to depict information (e.g., time-of-day, power levels, cell signal strength, control settings, song title, and so forth) while conserving power.

Implementing multiple display modes on a single display provides flexibility to designers of multi-function devices. They are able to configure modes of operating the display to support different capabilities and satisfy power requirements, without the cost and complexity of adding a second, separate display.

A single display with multiple display modes may be implemented in any number of devices. For discussion purposes, the display modes are described in the context of portable electronic devices, such as portable entertainment devices, portable digital assistants (PDAs), cellular phones, audio players, video players, notebook computers, digital cameras, laptop computers, and the like. Exemplary implementations are shown in FIGS. 1 and 6-11. However, the multi-display modes may be implemented in other non-portable devices that use displays, such as desktop personal computers and smart appliances.

Portable Entertainment Device

FIG. 1 shows a portable entertainment device 100 configured as a Portable Media Centerm device supported by Microsoft Corporation. The device 100 is a multifunction device that is capable of playing music and videos, depicting digital photos, downloading content from the Internet, and the like.

Device 100 has a body or casing 102 and a display panel 104 mounted centrally of the casing 102. The display panel 104 is a flat panel, color display with sufficient resolution to depict digital images or motion video. The display panel may optionally be implemented with a touch screen overlaying the display to facilitate user input. The display panel may be implemented using different technologies, including LCD (liquid crystal display), OLED (organic light emitting diode), plasma, and DLP (digital light processing).

Function control buttons 106 are positioned left of the display panel 104 to support user control of the device 100. In the illustrated implementation, the control buttons 106 include four directional buttons and an entry key. Shuttle control buttons 108 are positioned right of the display panel 104 to facilitate video playback. One or more other buttons may also be provided to permit control of other functions, such as volume, brightness, contrast, and so forth. It is noted that the device 100 is just one exemplary implementation, and that other configurations and physical layouts, with more or less buttons and features, may be used.

The display panel 104 may be operated in multiple modes, with each mode offering different functionality and varying levels of power consumption. Operating the single display panel in multiple modes enables the device 100 to offer essentially the functionality as conventional devices with two displays, but without the cost, complexity, and power considerations of adding a second display. In the described implementation, there are two modes of operation. In a first mode, the entire display panel is fully operational, where substantially all pixels and any backlighting are powered on and available to present image data in a full display mode area 110. The pixels are drawing power and ready for illumination, even if not all of them are used to depict images. While this mode offers the highest quality user experience, it is also consumes the most power of any mode of operation.

The display panel 104 may alternatively be operated in a second mode in which part of the display is operational while the rest of the display is powered off. In the second mode, the display panel provides a smaller area for depicting a reduced amount of image data (e.g., alphanumeric characters, small graphics, etc.), as represented by the partial display mode area 112. This partial display mode may be implemented by activating a subset of the pixels, while powering off or inactivating the remaining pixels. In FIG. 1, approximately one-sixth of the pixels are active in the partial display mode area 112, while the remaining five-sixths of the pixels are inactive and not drawing power. As a result, less power is consumed when operating in the partial display mode area 112 when compared to operating in the full display mode area 110. Additionally, or alternatively, the partial display mode might involve turning on or off portions of backlighting (if any) or circuitry that supports the display panel (e.g., frame buffer, display controller).

In addition to power conservation, the multiple display modes offer versatility from a single display. For instance, suppose the user wants to play music on the portable entertainment device 100. The device operates in the full display mode while the user browses the audio library and selects a song for play. FIG. 2 shows an example full screen 200 presented on the display panel 104 when operated in full display mode. Full screen 200 depicts a list of music titles, with a focus bar 202 that can be moved up and down along the song list to select a particular song title. Details of the music title highlighted by the focus bar 202 (i.e., song title 4) are presented in the lower, left-hand portion of the screen 200. Color graphics, video clips, and the like may further be depicted on the screen to enhance the user experience.

Once the user selects a song, the device 100 transitions to the partial display mode to conserve power, while still depicting enough information to inform the user of the current status of audio playback. FIG. 3 shows an example partial screen 300 presented on the display panel 104 when operated in a partial display mode. Partial screen 300 shows the album title, song name, and artist name to inform the user that the device is being operated as an audio player which is playing the identified song. The screen 300 may present the text in black and white, or optionally depict color or artistic elements such as an album cover.

Switching between full and partial display modes can be achieved in a number of ways. One approach is use of a mechanical switch that allows a user to physically choose a desired mode of operation. In FIG. 1, a switch 114 is mounted on a side of the case 102. Pressing or sliding the switch 114 to a first operational position selects the full display mode, and movement to a second operational position chooses the partial display mode. Rather than mechanical switches, another approach to switching modes is to allow user selection via soft-keys or other visual controls that are depicted as part of a graphical user interface on the display panel. In another implementation, software-generated events may dictate the appropriate mode of operation based on display requirements for particular functions. Activity time-out may be another approach to switch modes, where a period of inactivity triggers a transition from full display mode to partial display mode. Current battery level may also be used to decide when to switch modes. For example, when the battery level depletes to a specified threshold level, the device may switch from full display mode to partial display mode.

While only two modes are described in this implementation, more than two modes may be implemented. For instance, the device may be configured to operate the display panel in three modes, where the first mode involves a full screen, a second mode drives pixels in a first portion of the screen and a third mode drives another portion of the screen.

Device Architecture

FIG. 4 shows select functional components of the portable entertainment device 100 according to one exemplary implementation. In device 100, the display panel 104 is controlled by various electronic and software components, including a central processing unit (CPU) 402, a frame buffer memory 404, and a display panel controller 406. The display panel 104 may be implemented using different flat panel technologies, such as LCD, OLED, plasma, and DLP. The display panel has rows and columns of individually activated pixels, with an exemplary resolution of 660×480 pixels. Image data stored in the frame buffer 404 is provided to the pixels to form visual images.

A graphics driver 408 writes the image data into the frame buffer 404. The graphics driver 408 is illustrated as being implemented in software that executes on the CPU 402, but may alternatively be implemented in hardware. The CPU 402 may be a general-purpose processing unit, or a specially-tailored graphics processing unit.

The display controller 406 reads the image data from the frame buffer memory 404. If the frame buffer memory 404 stores image data for several graphic surfaces, the display controller 406 may also combine the surfaces into a single image. The display controller 406 sends the image data to driver circuits for the display panel. Generally, there are one or more row driver circuits to turn on rows of pixels in sequential order and one or more column driver circuits to place the image data received from the display controller 406 into the appropriate columns of pixels. The rows are turned on at a fast cycle rate to refresh the image data (e.g., 60 times per second).

In the implementation of FIG. 4, there are two row drivers 410(1) and 410(2) and three column drivers 412(1), 412(2), and 412(3). The drivers are used to control separate sets of pixels in the display panel 104. With a 660×480 display, for example, each row driver 410(1) or 410(2) might be configured to drive 240 rows of pixels and each column driver 412(1), 412(2), and 412(3) might be configured to drive 220 columns of pixels. More or less drivers may be used. Where multiple circuits are employed, the drivers are designed to communicate with one another as if being integrated as a single circuit.

Device 100 may optionally be configured with backlighting to provide additional lighting on the display panel 104. A backlight component 414 has three LEDs 416(1), 416(2), and 416(3) that are individually controlled by CPU 402 to selectively light all or portions of the display panel 104. The LEDs may be white or multi-color indicators. The LEDs are positioned along an edge of the display panel so that each illuminates approximately one-third of the panel. It is noted that more or less lights may be employed, and other backlighting arrangements may be used, including positioning the backlighting underneath the display panel.

A battery 418 supplies power to the components and display panel of the entertainment device 100. The battery 418 is preferably a rechargeable battery, such as a lithium-based battery.

The device 100 is further configured with a panel mode control driver 420 to select a display mode for the display panel 104. The panel mode control driver 402 implements mode switching functionality to choose among the various display modes, including the full display mode and the partial display mode. It is capable of controlling power to all or portions of the display panel 104, the backlight 414, and other circuitry that supports the display panel (e.g., frame buffer memory 404, display panel controller 406). The panel mode control driver 420 is illustrated as being implemented in software that executes on the CPU 402, but may alternatively be implemented at least partially in hardware.

The panel mode control driver 420 independently controls the row drivers 410, column drivers 412, backlight LEDs 416, frame buffer memory 404, and/or panel controller 406 to support multiple display modes. When in full display mode, the panel mode control driver 420 directs the row drivers and column drivers to drive all pixels of the display panel so that the pixels are active and ready for use. Image data received from the frame buffer memory 404 via the display panel controller 406 is placed on all columns of pixels and the rows are cycled to depict full screen images. Additionally, the panel mode control driver 420 turns on all LEDs 416(l)-416(3) of the backlight component 414. Accordingly, in the full display mode, the device 100 is capable of supporting applications that use a full-featured display. A user may use the full display mode to play movies, show digital images, read and write email, navigate menus, browse the Internet, and so forth.

The panel mode control driver 420 may switch from the full display mode to a partial display mode to conserve power or support a different set of display capabilities. In the partial display mode, the panel mode control driver 420 controls the row and column drivers to drive a subset of pixels. For instance, the panel mode control driver 420 might turn on the top row driver 410(1) and the middle column driver 412(2) exclusively of the other row and column drivers to activate exclusively the pixels in the top-middle section of the display indicated by the dashed rectangle. Image data received from the frame buffer memory 404 via the display panel controller 406 is placed on the middle-third columns (e.g., columns 220-439) driven by middle column driver 412(2) and the first half of the rows (e.g., rows 0-239) are cycled by top row driver 410(1) to depict images on a fraction of the screen. Thus, one-sixth of the pixels are active, while five-sixth of the pixels are inactive and not drawing power.

Additionally, in the partial display mode, the driver 420 might turn off all LEDs or turn on just the middle LED 416(2) of the backlight component 414. Image data stored in the frame buffer memory 404 can also be reduced to supply data only to the pixels in the top-middle section of the screen.

Thus, in the partial display mode, the device supports applications that use a limited-featured or reduced-size display. Information about a song being played (e.g., album title, song title, artist name), time-of-day, or system information (e.g., battery level, phone signal strength, mode data, etc.) are all examples of image data that might be displayed in the partial display mode. Since fewer components are driving fewer pixels, the partial display mode consumes significantly less power than the full display mode. Additional power savings result from powering down unused column and row drivers, and accessing less image data in the buffer memory.

While selection of separate drivers is illustrated in FIG. 4 to demonstrate how to activate a subset of pixels, it is noted that the panel mode control driver 420 may be configured to select individual columns and rows within a single driver or across multiple drivers. For example, the device 100 may be configured with a single row driver and a single column driver, and the panel mode control driver 420 be designed to direct the single drivers to drive subsets of the rows and columns within the display, thereby activating a subset of the pixels.

Also, while the illustrated example left one-sixth of the display panel operational in the partial display mode, there are many other possible configurations. In one alternative, the partial display mode might be configured to activate the pixels in the right-third of the display panel through controlling the right column driver 410(3) and both row drivers 410(1) and 410(2). Or, perhaps, the partial display mode might be configured to activate the middle of the display panel by selecting the lower rows of first row driver 410(1) and the upper rows of second row driver 410(2) and selecting the columns of middle column driver 412(2). With control of individual rows and columns, any number of layouts may be achieved in the partial display mode.

As noted above, the partial display mode may be implemented by selectively turning on and off the backlights, independently of controlling the row and column drivers. For example, the panel mode control driver 420 may turn on the first LED 416(1) while leaving the other two off to illuminate only the left side of the display panel 104. Leaving two-thirds of the backlighting off conserves power.

FIG. 5 shows the portable entertainment device 100 according to another exemplary implementation. The device 100 of FIG. 5 differs from that shown in FIG. 4 in that additional frame buffer memory and display panel controllers are integrated with the display driver circuitry. In the illustrated configuration, each column driver 412(1), 412(2), and 412(3) has a corresponding frame buffer (FB) 502(1), 502(2), and 502(3) to store image data and a corresponding display panel controller (DPC) 504(1), 504(2), and 502(3) to read the image data from the frame buffers and transfer the image data to the associated columns of pixels.

With this architecture, the panel mode control driver 420 can activate the appropriate small frame buffer(s) 502 and display panel controller(s) 504 when operating in partial display mode. For instance, to display images in the top-middle screen area referenced by the dashed rectangle, the panel mode control driver 420 activates the column driver 412(2), and the corresponding frame buffer 502(2) and display controller 504(2), to place image data on the appropriate pixels in this area. This allows the external frame buffer memory 404 and display panel controller 406 to power down, thereby conserving additional power.

While two different architectures are shown in FIGS. 4 and 5, there are many possible architectures for implementing multiple display modes in a device having a single display.

Other Representative Devices

The architectures for implementing multiple display modes on a single display panel can be implemented in many types of electronic devices. In addition to the portable entertainment device 100 of FIG. 1, three other representative devices are described below—an audio player, a cellular phone, and a portable computer.

FIGS. 6 and 7 show an audio player 600 that stores and plays digital music. The audio player 600 has two cover pieces 602(1) and 602(2) slidably mounted on a body 604. When the cover pieces 602(1) and 602(2) are slide to an open position (FIG. 6), a display panel 606 is exposed and operated in the full display mode. In this illustration, the display panel 606 depicts a feature box 608 identifying a current song title that is playing. Additionally, a first list of recently played song titles 610 are arranged above the feature box 608 and a second list of queued song titles 612 to be played are arranged beneath the feature box 608. One or more control buttons 614 are provided on the right-side cover piece 602(1) to enable user operation of the audio player 600, including navigation of the song lists.

FIG. 7 shows the audio player 600 when the cover pieces 602(1) and 602(2) are slide to a closed position to substantially cover the display panel 606. When the cover pieces are slid closed, the mechanical action triggers generation of a change event. In response to this event, the panel mode control driver 420 changes operation of the display panel 606 from full display mode to partial display mode. In this example, the image data is rotated 90° to fit within an opening formed by the two cover pieces 602(1) and 602(2). The visible portion of the display panel is active, while the hidden portion is powered down (e.g., backlighting of the hidden portion is off, rows/columns to the pixels in the hidden portion are off). Thus, operating the display in the second mode conserves power while still aiding user interaction with the device.

Notice that the dual display mode allows the same display panel to be used for both full-featured functionality (e.g., presentation and navigation of menu in FIG. 6) and reduced-feature functionality (e.g., presentation of current song title in FIG. 7).

FIGS. 8 and 9 show a cellular phone 800 that implements dual display modes with a single display panel. The cellular phone 800 is configured as a “clamshell” or “flip-phone” model having a lid 802 hingedly connected to a body 804. A display panel 806 and a keypad 808 are mounted on the body 804. The phone 800 may optionally be equipped with a camera lens 810 to capture digital images that can be presented on the display panel 806.

The lid 802 pivots about the hinge between an open position to expose the display panel 806 and keypad 808 (FIG. 8) and a closed position (FIG. 9). An opening 812 is cut through the lid 802 to reveal a portion of the display panel 806 when the lid 802 is in the closed position.

The panel mode control driver 420 operates the display panel 806 in the full display mode when the lid 802 is flipped open (FIG. 8). In this mode, the display panel is capable of depicting such image data as color images, video, email, graphics, and navigation menus. In this example, a mailbox of email is shown. When the user flips the lid closed (FIG. 9), the mechanical action is detected and in response, the panel mode control driver 420 changes operation of the display panel 806 from full display mode to partial display mode. In FIG. 9, the time-of-day and system symbols (e.g., cell signal strength, power level) are depicted on the portion of the display panel that is exposed through the opening 812 in the lid 802. In the partial display mode, the visible portion of the display panel under the lid opening 812 is active, while the hidden portion is powered down (e.g., backlighting of the hidden portion is off, rows/columns to the pixels in the hidden portion are off). The active portion when the lid is closed is represented in FIG. 8 as the region above the dashed line.

FIGS. 10 and 11 show a portable computer 1000 that implements dual display modes with a single flat display panel 1002. The panel mode control driver 420 alternately operates the flat display panel 1002 in a full display mode (FIG. 10) and a partial display mode (FIG. 11). In the full display mode, the flat display panel is a full functioning color display that can depict graphics, digital images, video, and so forth. In the partial display mode, only a portion of the display panel is powered on, as represented by screen area 1102, while the rest of the display panel is powered off. The small screen area 1102 may be used to show current time, reminders, news headlines, urgent e-mail notices, or other notifications and status. The driver 420 toggles between the two modes in response to any number of events, including an activity time-out, a software-generated event, battery level, or a user command.

Dual Display Mode Operation

FIG. 12 shows a process 1200 for operating a device with a single display panel in multiple display modes. The process 1200 is illustrated as a collection of blocks in a logical flow graph, which represent a sequence of operations that can be implemented in hardware, software, or a combination thereof. In the context of software, the blocks represent computer instructions that, when executed by one or more processors, perform the recited operations.

For discussion purposes, the process 1200 is described with reference to the portable entertainment device 100 and architecture shown in FIG. 4. It is noted that the process 1200 may be implemented by other devices and architectures.

At block 1202, the device 100 operates in the full display mode, such as that illustrated in FIG. 2. In this mode, the display panel is fully operational and all pixels are available to depict image data.

At block 1204, the panel mode control driver 420 detects a full-to-partial mode change event, which initiates a conversion from the full display mode to the partial display mode. Such an event may be mechanical detection of the user interaction with the device, such as pressing the switch 114 on device 100, or sliding closed the covers on the audio player 600, or closing the lid of cellular phone 800. Alternatively, the event may be triggered by an activity time-out that suggests the user is no longer interacting with the device. For a time-out condition, the device converts to the partial display mode as a way to conserve power. Another full-to-partial mode change event might be generated by software running on the device. Audio playback software, for example, may direct the device to convert to the partial display mode in response to a user selecting a particular song title or album. Still another full-to-partial mode change event might be triggered by direct user request. The user may stipulate conditions when to operate in partial display mode, or may input a direct command to change the display mode. Another triggering event may be battery level, where the device switches to partial display mode when the battery level falls below a certain threshold.

At block 1206, in response to the full-to-partial mode change event, the device 100 operates in the partial display mode, such as that illustrated in FIG. 3. In partial display mode, a portion of the display panel 104 is used to depict images and information. The partial display mode may be achieved by driving less than all pixels, turning on less than all backlight LEDs, and/or using less than all components responsible for transferring the image data to the pixels. Example techniques for operating in the partial display mode include:
Controlling row and column drivers to select rows and columns that define a subset of the pixels, while unused rows and columns are powered down.
Controlling panel backlights to select a subset of backlighting for illumination, while unused backlighting is powered down.
Using a portion of the frame buffer memory to hold image data for the reduced screen area, while unused buffer memory is turned off.
Use small frame buffer memory associated with the selected column drivers, allowing the device to power down the system frame buffer, as supported in the architecture of FIG. 5.
Use small display panel controller associated with the selected column drivers, allowing the device to power down the system display panel controller, as supported in the architecture of FIG. 5.

The partial display mode allows the device to conserver power, yet still provides useful information to assist the user when interacting with the device.

At block 1208, the panel mode control driver 420 detects a partial-to-full mode change event, which triggers a conversion from the partial display mode back to the full display mode. The partial-to-full mode change event may be mechanically triggered (e.g., pressing the switch 114 on device 100, opening a flip phone, etc.) or a software generated event. In response to the change event, the device begins operating in full display mode again (block 1202).

FIG. 13 shows another process 1300 for using the dual display modes with hardware and software designed to support two separate display panels. Given the growing number of devices having two displays, there are many existing components that are already designed for such devices. The existing hardware and/or software components designate image data for display on either the large display or the small display. The technologies described in this disclosure may be implemented in a way that is compatible with these existing components.

At block 1302, the data designated for either the large display or the small display is received. At block 1304, the panel mode control driver 420 determines whether the data is intended for presentation on the large display or the small display. If intended for the large display (i.e., the “large” branch from block 1304), the panel mode control driver 420 operates the single display panel in full display mode to depict the data using a fully active display. Conversely, if the data is intended for the small display (i.e., the “small” branch from block 1304), the panel mode control driver 420 operates the single display panel in partial display mode to depict the data using a limited-feature display where part of the display panel is powered down.

Additionally, there can be a cost associated with switching between full and partial display modes. Accordingly, the device may optionally determine, before making a switch, whether the data is well suited for the opposite display mode given the intended display duration. For instance, if the device is operating in full display mode and the data is designated for a small display, the device may first determine the computation and power cost of switching to a partial display mode for the duration of depicting the data and then determine whether switching to the partial display mode is worth the cost.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A device comprising:
a memory to store image data;
a display to present the image data stored in the memory, the display having multiple pixels; and
a mode control driver to operate the display (1) in a first mode that supports full display capabilities where the pixels are available for displaying the image data and (2) in a second mode that supports limited display capabilities where a subset of the pixels are available for displaying the image data and remaining pixels are not available.

2. A device as recited in claim 1, wherein the mode control driver switches between the first and second modes in response to detection of a mechanical switch.

3. A device as recited in claim 1, wherein the mode control driver switches between the first and second modes in response to at least one of a software-generated event, an activity time-out event, or battery level.

4. A device as recited in claim 1, further comprising:
driver circuitry to drive selectively rows and columns of the pixels; and
the mode control driver being configured to power off the rows and the columns associated with the pixels that are not available when the display is operating in the second mode.

5. A device as recited in claim 1, further comprising:
multiple row drivers for driving associated rows of the pixels;
multiple column drivers for driving associated columns of the pixels; and
the mode control driver, when operating in the second mode, powers off at least one of (1) one or more of the row drivers, and (2) one or more of the column drivers, to select the subset of pixels that are available for displaying the image data.

6. A device as recited in claim 1, further comprising multiple backlights to illuminate the display, the mode control driver powering on select backlights and powering off other backlights when operating the display in the second mode.

7. A device as recited in claim 1, embodied as a portable electronic device selected from a group of devices comprising a cellular phone, a portable entertainment device, a portable digital assistant, an audio player, and a portable computer.

8. A computer readable media storing computer-executable instructions that, when executed by a processor, directs an electronic device to perform acts comprising:
operating a display panel on the electronics device in a first mode where the display panel is operational to display data; and
operating the display panel in a second mode where a portion of the display panel is operational to display the data while a remaining portion of the display panel is powered down.

9. A computer readable media as recited in claim 8, wherein the display panel has multiple pixels, and all of the pixels are available for displaying the data in the first mode and only a subset of the pixels are available for displaying the data in the second mode.

10. A computer readable media as recited in claim 8, wherein the remaining portion of the display panel is powered down by turning off rows and columns for pixels resident in the remaining portion of the display panel.

11. A computer readable media as recited in claim 8, wherein the remaining portion of the display panel is powered down by turning off backlighting that otherwise illuminates the remaining portion of the display panel.

12. A computer readable media as recited in claim 8, further storing computer-executable instructions that, when executed by a processor, directs the electronic device to perform acts comprising:
receiving data designated for display on one of a first display or a second display;
displaying the data designated for the first display while operating in the first mode; and
displaying the data designated for the second display while operating in the second mode.

13. A device comprising:
a display panel;
the computer readable media as recited in claim 8; and
a processor to execute the instructions stored on the computer readable media.

14. A method, comprising:
determining whether to operate a display panel in a first mode of operation or a second mode of operation;
in an event the first mode of operation is selected, operating the panel display with substantially all pixels active; and
in the second mode of operation, operating the panel display with a subset of the pixels active and remaining pixels inactive.

15. A method as recited in claim 14, wherein the determining comprises detecting mechanical selection of the first mode or the second mode.

16. A method as recited in claim 14, wherein the determining comprises toggling between the first mode and the second mode in response to a software-generated event.

17. A method as recited in claim 14, wherein the determining comprises switching from the first mode to the second mode in response to a time-out condition.

18. A method as recited in claim 14, wherein operating the display panel in the second mode of operation comprises powering on rows and columns that control the subset of the pixels and powering off other rows and columns.

19. A method as recited in claim 14, wherein the display panel includes backlighting, further comprising operating the display panel in the second mode of operation by powering on a portion of the backlighting and powering off another portion of the backlighting.

20. A method as recited in claim 14, further comprising:
receiving data designated for display on one of a first display or a second display;
displaying the data designated for the first display while operating in the first mode; and
displaying the data designated for the second display while operating in the second mode.
